(19) United States
(12) Patent Application Publication
(10) Pub. No.: US 2016/0150759 A1
(43) Pub. Date: Jun. 2, 2016

(54) METHOD OF CONFINING MOVEMENT OF PETS

(71) Applicant: Nancy Lynn Carra, Rockdale, IL (US)

(72) Inventor: Nancy Lynn Carra, Rockdale, IL (US)

(21) Appl. No.: 14/557,563

(22) Filed: Dec. 2, 2014

(51) Int. Cl. A01K 3/00; A01K 1/04; A01K 29/00

(52) U.S. Cl. CPC A01K 3/00; A01K 29/00; A01K 1/04

(57) ABSTRACT

A method of confining movement of a pet using a track system having at least one track component with a length along which a travel path is defined. The track system has a traveling assembly that is movable guidingly relative to the at least one track component along a pre-defined travel path. The at least one track component is secured to a base to fix the at least one track component in an operative position. A tether system is connected between the traveling assembly and the pet in a manner whereby as the pet moves the tether system causes the traveling assembly to move relative to the at least one track component in the travel path.

### BACKGROUND OF THE INVENTION

1. Field of the Invention

This invention relates to a system through which movement of pets can be controllably confined to within a predetermined path.

2. Background Art

Owners of pets, such as dogs, have long contended with the problem of confining movement of their pets when they are unattended outdoors. Fencing is not always an option because of aesthetic concerns or difficulty in complying with local codes or covenants.

One well-known system is commonly identified as an “electric fence”. These systems require that the pet wear an electronic component that interacts with an electronic boundary assembly traced around an area within which the pet is to be confined. In the event that the pet approaches the boundary assembly, the pet is given a slight shock. Eventually, the pet becomes trained to the presence of the boundary assembly and limits movement to be within the bounded area.

While electric fences have been effective, they do have some drawbacks. First of all, they rely upon electronics which have a reasonably high potential for failure when utilized in an environment wherein they will be subjected to impacts, severe weather conditions, etc. Reliable electronics often require a significant financial investment. Further, dogs may purposely remove the transmitter which they sense as an irritant or, alternatively, the transmitter may be torn off as the pet moves through brush, etc.

It is known to use elongate tethers to confine pet movement. In one form, a stake may be anchored into the ground to fix one end of the tether.

While this type of system is generally effective, it too has drawbacks. If the tether is short, the pet has a relatively limited area within which it can move. If the tether is made longer, the tether may become tangled independently or with the pet.

In an alternative tether system, an elongate line is spanned between two supports. A guide element is provided on one end of the tether and moves guidingly along the line.

Again, this system, while generally effective, has drawbacks. Most significantly, the line, which is elevated above the ground, becomes a potential obstruction or danger. Persons in the vicinity may walk into the line or trip thereover. If the line is used in an area where regular maintenance is performed, the line may have to be removed to permit this maintenance to be carried out.

With the vast amount of vehicular traffic in most urban areas and the overall need to control interaction between pets and persons in the vicinity of where the pets reside, confining pets in a controlled manner becomes increasingly important. Systems designed for this purpose must be effective, practical and affordable. In the absence of a viable system for a particular pet owner, the pet owner often lets his/her pet roam freely, whereby the pet owner faces the possibility of injury to the pet or injury to other pets or persons by their pet. The industry continues to seek out effective systems for controlling pet movement.

### SUMMARY OF THE INVENTION

In one form, the invention is directed to a method of confining movement of a pet. The method includes the step of obtaining a track system having at least one track component with a length along which a travel path is defined. The track system further includes a traveling assembly. The at least one track component and traveling assembly are configured to cooperate so that the traveling assembly is movable guidingly relative to the at least one track component along a pre-defined travel path. The method further includes the steps of: securing the at least one track component to a base to fix the at least one track component in an operative position; and connecting a tether system between the traveling assembly and the pet in a manner whereby as the pet moves the tether system causes the traveling assembly to move relative to the at least one track component in the travel path.

In one form, the step of securing the at least one track component involves embedding the at least one track component in a subjacent base.

In one form, the at least one track component has a height. The step of embedding the at least one track component involves embedding a majority of the height of the at least one track component in the subjacent base.

In one form, the base has an upwardly facing surface. The at least one track component has a height between a top and bottom. The step of embedding the at least one track component involves embedding the at least one track component so that the top of the at least one track component is substantially flush with the upwardly facing base surface.

In one form, the step of providing a track system involves providing a track system wherein the at least one track component has an upwardly opening cavity in which the traveling assembly moves in the travel path.

In one form, the step of providing a track system involves providing a track system wherein the at least one track component includes a plurality of track components. The method further includes the step of joining a first and second of the plurality of track components together.

In one form, the step of joining the first and second track components together involves press fitting the first and second track components together.

In one form, the step of securing the at least one track component involves directing a fastener through a part of the at least one track component and into the base.

In one form, the step of providing a track system involves providing a track system wherein the at least one track component includes first and second track components that have a fixed shape.

In one form, the step of providing a track system involves providing a track system wherein the first and second track components have different shapes defining different travel path portion configurations.

In one form, the step of providing a track system involves providing a track system wherein the traveling assembly has a connection for the tether system. The method further includes the step of releasably connecting the tether system to the connector.

In one form, the step of providing a track system involves providing a track system wherein the at least one track component has an elongate body with a length and a flange projecting transversely to the body length. The method further includes the step of directing a fastener through the flange and into the base.

In one form, step of providing a track system involves providing a track system wherein the at least one track component has a body with at least one drain opening formed therein.

### BRIEF DESCRIPTION OF THE DRAWINGS

FIG. 1 is a schematic representation of a track system according to the present invention utilized to confine movement of a pet;

FIG. 2 is a flow diagram representation of a method of confining movement of a pet utilizing the system in FIG. 1;

FIG. 3 is a plan view of one specific form of track component making up part of the track system in FIG. 1;

FIG. 4 is an enlarged, cross-sectional view of the track component in FIG. 3 in an operative position embedded in a base;

FIG. 5 is an enlarged, fragmentary, side elevation view of the track component in FIG. 3 with fasteners partially directed therethrough;

FIG. 6 is an enlarged view corresponding to that in FIG. 3;

FIG. 7 is a plan view of one specific form of track system as shown schematically in FIG. 1;

FIG. 8 is a view as in FIG. 7 of a modified form of track system; and

FIG. 9 is a view as in FIGS. 7 and 8 of a still further modified form of track system.

### DETAILED DESCRIPTION OF THE PREFERRED EMBODIMENT

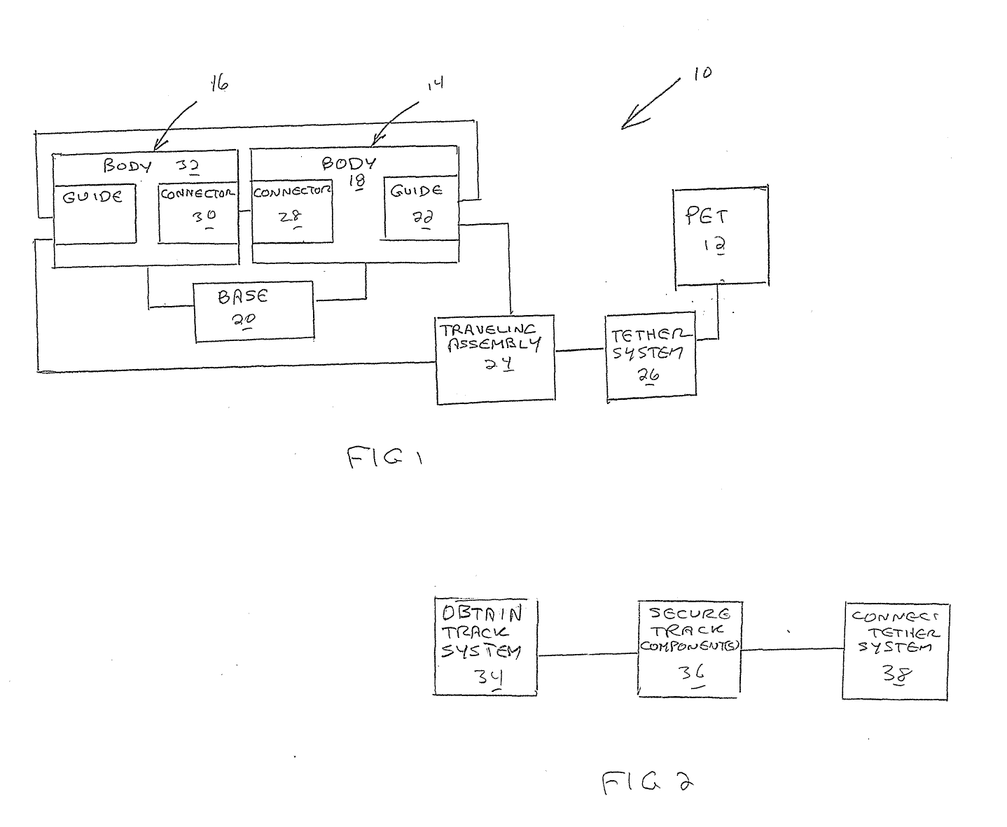

In FIG. 1, there is a schematic representation of a track system at 10 used to practice the inventive method of confining movement of a pet 12. The schematic representation is intended to encompass the specific forms of the track system as shown in the Figures herein and described hereinbelow, and variations of the described components and their interaction. Virtually an unlimited number of different component configurations and interactions therebetween might be readily derived by one skilled in the art with the inventive teachings in hand. The schematic representation is intended to encompass all of those variations.

The track system 10 consists of at least one track component, with representative first and second track components 14, 16 depicted. Exemplary track component 14 has an elongate body 18 with a length along which all, or a portion, of a desired travel path is defined. The body 18 is secured to a base 20 that may be any stable structure, regardless of its orientation. Preferably, the base 20 would be a subjacent support, such as a lawn area in a pet owner's yard. The body 18 is fixedly secured to the base 20 to place the track component 14 in an operative position. The securing may be effected by embedding the track component 14 in the base 20 and/or by using one or more fasteners.

The body defines a guide 22 for a traveling assembly 24. The traveling assembly 24 is guided in the pre-defined travel path portion by the guide 22 on the body 18.

A tether system 26 connects between the traveling assembly 24 and pet 12 such that as the pet moves, the tether system causes the traveling assembly 24 to move relative to the track component 14 in the travel path portion defined thereby.

The track component 16 can be operatively joined to the track component 14 through cooperating connectors 28, 30, respectively on the body 18 of the connector 14 and a like body 32 on the track component 16. In one preferred form, as depicted, the connectors 28, 30 are configured to intermesh to allow them to be press fit into assembled relationship. With the track components 14, 16 in assembled relationship, they cooperatively define the travel path for the traveling assembly 24.

With the track system 10, as described above, the inventive method of confining movement of a pet can be carried out as shown in flow diagram form in FIG. 2.

As shown at block 34, the track system is obtained.

As shown at block 36, the one or more track components are secured.

As shown at block 38, the tether system is connected between a traveling assembly on the track component(s) and the pet to be confined.

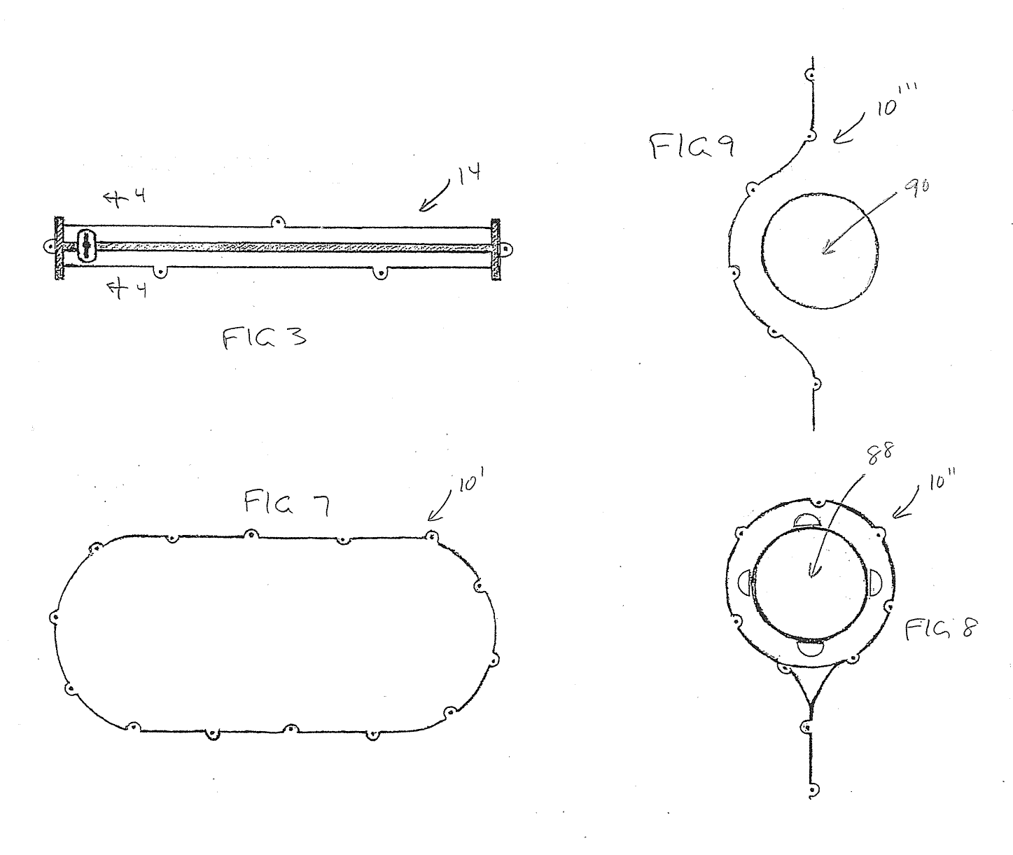

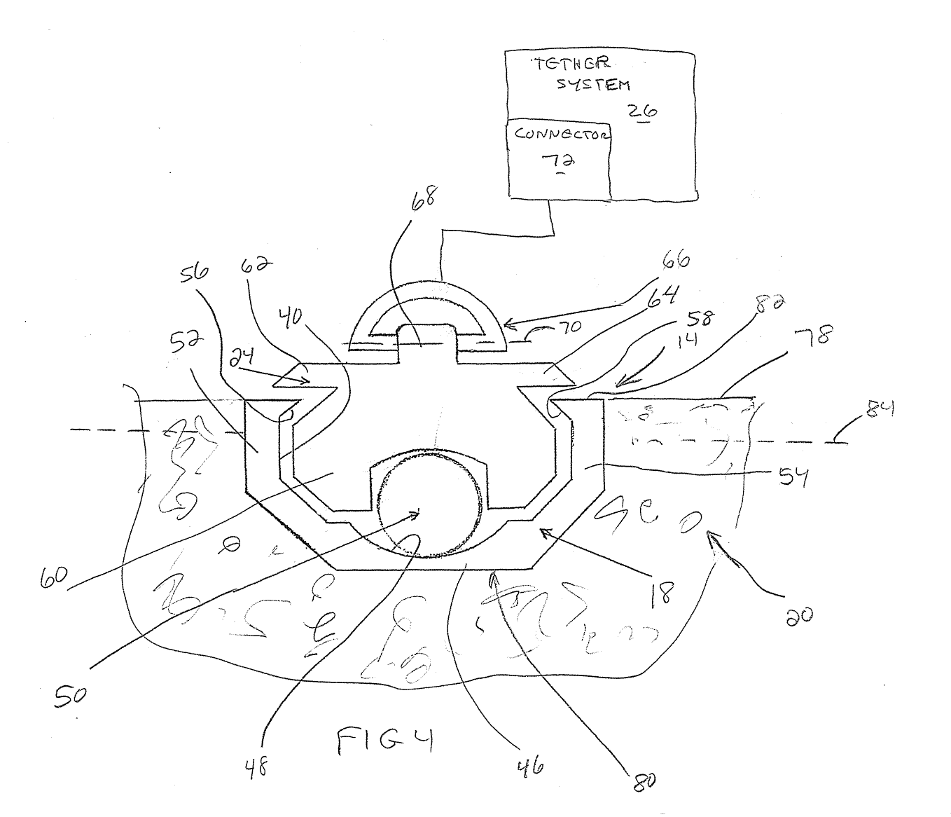

Specific forms of the track system 10 are shown in FIGS. 3-9 and described hereinbelow.

In FIGS. 3-6, the track component 14 is shown wherein the elongate body 18 has a generally upwardly opening “U” shape defining a cavity 40 in which the traveling assembly 24 moves guidingly in the pre-defined travel path portion between spaced lengthwise ends 42, 44.

As seen most clearly in FIG. 4, the base 46 of the “U” defines a guide channel 48 along which a ball-type component 50 on the traveling assembly 24 rolls between the body ends 42, 44 in the travel path portion defined by the track component 14.

Spaced legs 52, 54 of the “U” respectively have in-turned ends 56, 58 that cooperatively capture a main body portion 60 on the traveling assembly 24 in conjunction with the base 46. The main body portion 60 extends into oppositely projecting legs 62, 64, that respectively overlie the legs 62, 64.

A D-ring 66 is connected to a boss 68 on the main body portion 60 so as to allow pivoting relative thereto around an axis 70. Through an appropriate connector 72, that may be a snap-fit mechanism, the tether system 26 can be operatively connected to the D-ring 66 whereby the force of the pet drawing on the tether system 26 causes the D-ring 66 and traveling assembly 24 to move back and forth along the length of the body 18 in the pre-defined travel path portion.

In this embodiment, the body 18 incorporates a connector 30 that is the same as the connector 30 on the track component 16 at its one end 44. The opposite end 42 has the connector 28 thereon. With this arrangement, the connectors 28, 30 can be press fit with complementary connectors 28, 30 on one or more additional track components that can be serially joined to produce a desired length and shape for the overall system 10.

The body 18 has at least one, and in this case three, generally flat flanges 74, each projecting transversely to the length of the body 18. Each flange 74 is designed to accept a fastener 76 that can be directed through the flange 74 and into the base 20. In this embodiment, the fasteners 76 are shown in the form of threaded-type stakes. The fasteners 76 may be driven into the base 20 or turned to secure the body 18 relative to the base 20.

The body 18 may be made with a fixed shape so that the configuration of the travel path portion is likewise fixed. Alternatively, as shown in FIG. 6 in dotted lines, the body 18 may be made from a flexible material that allows reconfiguration thereof and the travel path portion defined thereby.

The body 18 may be secured by directing the fasteners 76 into a surface 78 against which a bottom at 80 of the body 18 abuts.

Alternatively, and preferably, the body 18 is embedded in the base 20. The embedding may be carried out so that the top 82 of the body 18 is flush with the base surface 78.

Complete embedding is not required, as the embedding may occur to a lesser height, as indicated by the dotted line 84. In the latter case, preferably a majority of the height of the body 18 is embedded.

To prevent accumulation of moisture within the cavity, a drain opening/vent 86 is formed through the body 18.

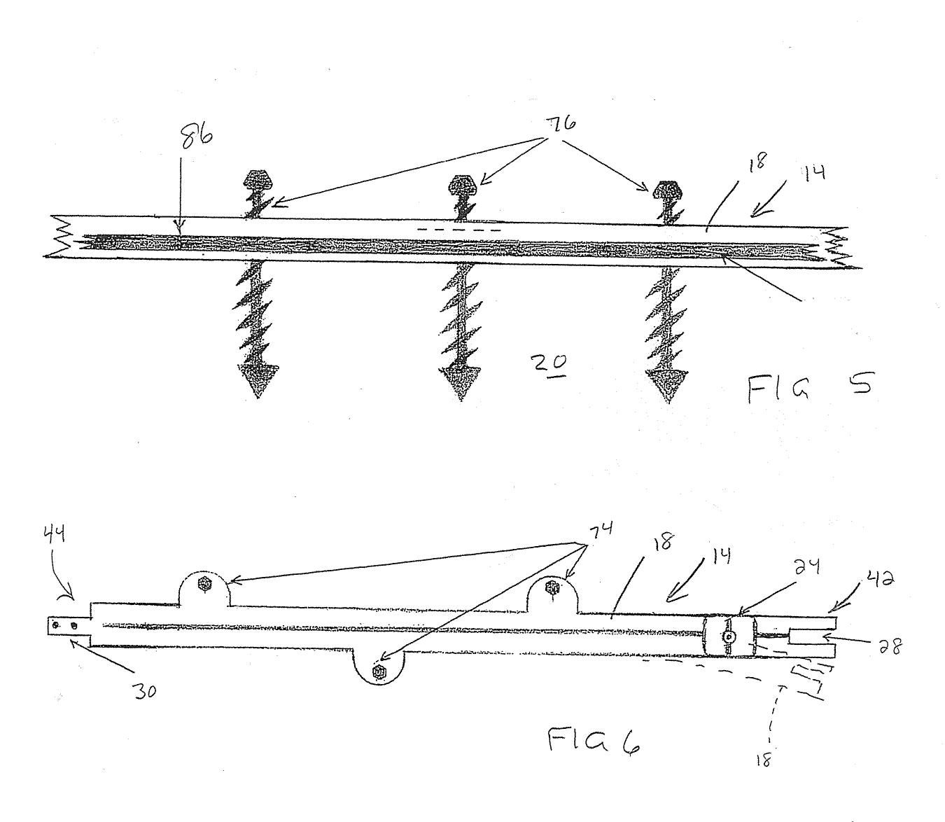

FIGS. 7-9 identify different track system layouts that may be defined by a single track component or multiple track components that are joined together, either permanently or releasably, as by press fitting, or otherwise.

In FIG. 7, a track system is shown at 10′ consisting of a continuous body arrangement wherein an oval travel path is defined.

In FIG. 8, a track system 10″ is shown formed around the perimeter of a lawn furniture ensemble 88.

In FIG. 9, a further modified form of track system is shown at 10″ extending around a tree or bush 90.

The individual track components may be made to produce any desired shape. As noted, the track system 10 may be made in modular form with serially joined components or from a single track component in any desired shape.

The foregoing disclosure of specific embodiments is intended to be illustrative of the broad concepts comprehended by the invention.

1. A method of confining movement of a pet, the method comprising the steps of:
obtaining a track system comprising at least one track component having a length along which a travel path is defined,
the track system further comprising a traveling assembly,
the at least one track component and traveling assembly configured to cooperate so that the traveling assembly is movable guidingly relative to the at least one track component along a pre-defined travel path;
securing the at least one track component to a base to fix the at least one track component in an operative position; and
connecting a tether system between the traveling assembly and the pet in a manner whereby as the pet moves the tether system causes the traveling assembly to move relative to the at least one track component in the travel path.

2. The method of confining movement of a pet according to claim 1 wherein the step of securing the at least one track component comprises embedding the at least one track component in a subjacent base.

3. The method of confining movement of a pet according to claim 2 wherein the at least one track component has a height, and the step of embedding the at least one track component comprises embedding a majority of the height of the at least one track component in the subjacent base.

4. The method of confining movement of a pet according to claim 2 wherein the base has an upwardly facing surface, the at least one track component has a height between a top and bottom and the step of embedding the at least one track component comprises embedding the at least one track component so that the top of the at least one track component is substantially flush with the upwardly facing base surface.

5. The method of confining movement of a pet according to claim 1 wherein the step of providing a track system comprises providing a track system wherein the at least one track component has an upwardly opening cavity in which the traveling assembly moves in the travel path.

6. The method of confining movement of a pet according to claim 1 wherein the step of providing a track system comprises providing a track system wherein the at least one track component comprises a plurality of track components, the method further comprising the step of joining a first and second of the plurality of track components together.

7. The method of confining movement of a pet according to claim 6 wherein the step of joining the first and second track components together comprises press fitting the first and second track components together.

8. The method of confining movement of a pet according to claim 1 wherein the step of securing the at least one track component comprises directing a fastener through a part of the at least one track component and into the base.

9. The method of confining movement of a pet according to claim 1 wherein the step of providing a track system comprises providing a track system wherein the at least one track component comprises first and second track components that have a fixed shape.

10. The method of confining movement of a pet according to claim 9 wherein the step of providing a track system comprises providing a track system wherein the first and second track components have different shapes defining different travel path portion configurations.

11. The method of confining movement of a pet according to claim 1 wherein the step of providing a track system comprises providing a track system wherein the traveling assembly has a connection for the tether system and further comprising the step of releasably connecting the tether system to the connector.

12. The method of confining movement of a pet according to claim 1 wherein the step of providing a track system comprises providing a track system wherein the at least one track component comprises an elongate body with a length and a flange projecting transversely to the body length and further comprising the step of directing a fastener through the flange and into the base.

13. The method of confining movement of a pet according to claim 1 wherein the step of providing a track system comprises providing a track system wherein the at least one track component comprises a body with at least one drain opening formed therein.
